(19) United States
(12) Patent Application Publication
(10) Pub. No.: US 2025/0237753 A1
(43) Pub. Date: Jul. 24, 2025

(54) Extrinsic geometric calibration method for a three-dimensional-data acquisition system

(71) Applicant: Continental Autonomous Mobility Germany GmbH, Ingolstadt (DE)

(72) Inventors: Boris LUGEZ, Toulouse (FR); Thomas MENEYROL, Toulouse (FR)

(21) Appl. No.: 18/698,427

(22) PCT Filed: Oct. 21, 2022
(86) PCT No.: PCT/EP2022/079428

§ 371 Date: Apr. 4, 2024

(30) Foreign Application Priority Data
Oct. 21, 2021 (FR) FR2111211

(51) Int. Cl. G01S 7/497; G01S 17/89

(52) U.S. Cl. CPC G01S 7/4972; G01S 17/89

(57) ABSTRACT

An extrinsic geometric calibration method for a system for acquiring three-dimensional data including at least one sensor for taking three-dimensional measurements that is associated with a sensor frame, which method aims to define the geometric transformation between the sensor frame and a world frame, by a set of static targets. The method includes an initial step of locating the targets, which aims to determine the coordinates of the targets in the sensor frame by the sensor for taking three-dimensional measurements, a first step of estimating the roll, the pitch and the vertical translation by minimizing a first cost function based on the geometric characteristic of arrangement of the targets on the calibration plane, and a second step of estimating the yaw, the longitudinal translation and the transverse translation by minimizing a plurality of second cost functions based on the geometric characteristic of alignment of the targets in the world frame.

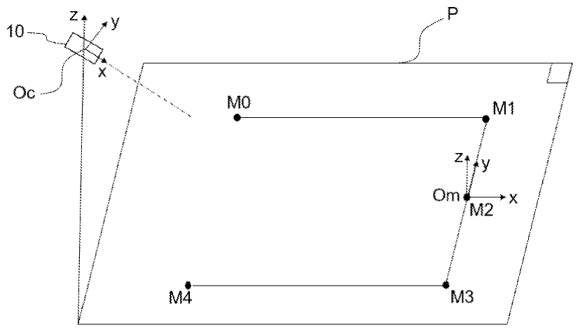

### CROSS REFERENCE TO RELATED APPLICATIONS

This application is the U.S. National Phase Application of PCT International Application No. PCT/EP2022/079428, filed Oct. 21, 2022, which claims priority to French Application No. 2111211, filed Oct. 21, 2021, the contents of such applications being incorporated by reference herein.

### FIELD OF THE INVENTION

The present patent application relates to extrinsic geometric calibration for a system for acquiring three-dimensional data by means of static targets.

### BACKGROUND OF THE INVENTION

It is known to use a system for acquiring three-dimensional data, in particular to generate three-dimensional maps that can be used by a computer, for example with the aim of assisting the driver of a vehicle by detecting an obstacle or by estimating the time before collision with an obstacle.

The three-dimensional data are generally acquired by means of a sensor for taking three-dimensional measurements, for example a camera or lidar (acronym of light detection and ranging) associated with a computer.

The data acquired by the sensor for taking three-dimensional measurements are referenced in the Cartesian frame of the sensor using an intrinsic calibration of the sensor.

In addition, it is necessary to carry out an extrinsic geometric calibration of the sensor in order to be able to express the points detected by the sensor for taking three-dimensional measurements in another frame, for example a world frame.

The extrinsic calibration of the sensor for taking three-dimensional measurements consists in estimating the relative position between the sensor for taking three-dimensional measurements and a frame in which the acquired data are used, which will be called the world frame below.

In other words, the extrinsic calibration of the sensor for taking three-dimensional measurements consists in determining the geometric transformation between the sensor frame and the world frame.

The geometric transformation that allows the calibration of the sensor is characterized by extrinsic parameters that comprise three angles of rotation including roll about a longitudinal axis of the world frame, pitch about a transverse axis of the world frame and yaw about a vertical axis of the world frame, and three translations including a transverse translation, a longitudinal translation and a vertical translation.

In order to define this geometric transformation and to carry out an extrinsic calibration of the sensor for taking three-dimensional measurements, it is known to use an extrinsic calibration method that aims to determine the coordinates of a plurality of calibration targets in the sensor frame, by means of the sensor for taking three-dimensional measurements.

In this type of extrinsic calibration method, the targets are static and are arranged in the scene captured by the sensor for taking three-dimensional measurements in precise positions, on a checkerboard for example.

Also, an extrinsic self-calibration method is known that does not require calibration targets but that does require the sensor for taking three-dimensional measurements to be trained while moving.

The above-described method of extrinsic calibration of the sensor for taking three-dimensional measurements places positioning constraints on the calibration targets, which must be precisely positioned, this limiting the flexibility and speed of implementation of such a calibration method.

The automatic methods of extrinsic calibration of the sensor for taking three-dimensional measurements are prohibitive here because they require the measurement-taking sensor to be set in motion.

### SUMMARY OF THE INVENTION

An aspect of the present invention in particular aims to solve these drawbacks.

This and other aspects that will become apparent on reading the following description, is achieved with an extrinsic geometric calibration method for a system for acquiring three-dimensional data comprising at least one sensor for taking three-dimensional measurements that is associated with a sensor frame, which method aims to define the geometric transformation between the sensor frame and a world frame, by means of a set of static targets, the geometric transformation being characterized by extrinsic parameters that comprise, with reference to the world frame, three angles of rotation including roll about a longitudinal axis, pitch about a transverse axis and yaw about a vertical axis, and three translations including a longitudinal translation, a transverse translation and a vertical translation, characterized in that the set of targets comprises at least three non-collinear targets that are arranged on a flat surface forming a calibration plane, and that are placed so that the set of targets comprises at least:
two targets aligned along the longitudinal axis of the world frame,
two targets aligned along the transverse axis of the world frame, and
a target arranged at the origin of the world frame, and in that the method comprises at least:
an initial step of locating the targets, which aims to determine the coordinates of the targets in the sensor frame by means of the sensor for taking three-dimensional measurements,
a first step of estimating the roll, the pitch and the vertical translation by minimizing a first cost function based on the geometric characteristic of arrangement of the targets on said flat surface forming a calibration plane, and
a second step of estimating the yaw, the longitudinal translation and the transverse translation by minimizing a plurality of second cost functions based on the geometric characteristic of alignment of the targets in the world frame.

According to other optional features of the method according to an aspect of the invention, taken individually or in combination:
the first cost function used in the first estimating step is the following cost function:

$$cost ( Rx , Ry , Tz ) = \vert Rx . Ry . [ 0 ; 0 ; 1 ] . Mci + Tz \vert$$

with Mci the coordinates of the indexed target, in the sensor frame;
the second cost functions used in the second estimating step are at least the following cost functions:

$$cost ( Rz , Tx , Ty ) = ‖ Mm 0. y - Mm 1. y ‖ ,$$

$$cost ( Rz , Rx , Ty ) = ‖ Mm 1. x ‖ ,$$

$$cost ( Rz , Rx , Ty ) = ‖ Mm 2. x ‖ , and$$

$$cost ( Rz , Rx , Ty ) = ‖ Mm 2. y ‖ ,$$

with Mm0·y and Mm1·y the coordinates along the transverse axis of the targets aligned along the longitudinal axis in the world frame, and with Mm1·x, Mm2·x the coordinates along the longitudinal axis of the targets aligned along the transverse axis in the world frame, and with Mm2·x, Mm2·y the coordinates along the longitudinal axis and the transverse axis of the target arranged at the origin of the world frame;
the set of targets comprises five targets that are arranged in a U-shape on the calibration plane, so that, with reference to the world frame, two targets are aligned along the longitudinal axis, three targets are aligned along the transverse axis, two targets are aligned along the longitudinal axis and two targets are aligned along the transverse axis and one target is arranged at the origin of the world frame;
the second cost functions used in the second estimating step are at least the following cost functions:

$$cost ( Rz , Tx , Ty ) = ‖ Mm 3. y - Mm 4. y ‖ ,$$

$$cost ( Rz , Tx , Ty ) = ‖ Mm 0. x - Mm 4. x ‖ , and$$

$$cost ( Rz , Tx , Ty ) = ‖ Mm 3. x ‖ ,$$

with Mm3·y and Mm3·y the coordinates along the transverse axis of the targets aligned along the longitudinal axis in the world frame, and with Mm0·x, Mm4·x the coordinates along the longitudinal axis of the targets aligned along the transverse axis and with Mm3·x the coordinate along the longitudinal axis of one of the three targets aligned along the transverse axis;
the targets are each equipped with a device for facilitating reflectance of light rays in order to facilitate the initial step of locating the targets by means of the sensor for taking three-dimensional measurements;
said sensor for taking three-dimensional measurements is a lidar.

### BRIEF DESCRIPTION OF THE DRAWINGS

Other features and advantages of aspects of the invention will become apparent on reading the following description, with reference to the appended Figure, which illustrates:
a schematic view of five static targets arranged on a piece of ground forming a calibration plane, and a sensor for taking three-dimensional measurements that is intended to be calibrated by means of the targets and via a calibration method according to an aspect of the invention.

To increase the clarity of the text of the present patent application, the terminology longitudinal, vertical and transverse will be used, in a non-limiting way, to refer to the axes Omx, Omz and Omy of the world frame Om indicated in the Figure, respectively, the calibration plane P being considered to be horizontal.

### DETAILED DESCRIPTION OF THE PREFERRED EMBODIMENTS

The Figure shows a sensor 10 for taking three-dimensional measurements that is associated with an orthonormal sensor frame Oc defined by the longitudinal, transverse and vertical axes Ocx, Ocy, Ocz, respectively.

The sensor 10 for taking three-dimensional measurements is a lidar (acronym of light detection and ranging) that belongs to a data-acquiring system.

By way of non-limiting example, the sensor 10 for taking three-dimensional measurements may be a stereoscopic camera or any other device suitable for measuring the distance of a point with respect to the sensor 10.

According to one variant of an aspect of the invention which is not shown, the acquiring system comprises a plurality of sensors 10 for taking three-dimensional measurements.

Thus, the Figure illustrates a set of five static calibration targets M0, M1, M2, M3, M4 that each form one point in an orthonormal world frame Om defined by the longitudinal, transverse and vertical axes Omx, Omy, Omz, respectively.

The targets M0, M1, M2, M3, M4 are arranged on a flat surface forming a calibration plane P, and for example on a flat piece of ground.

With reference to the Figure, the targets M0, M1, M2, M3, M4 are arranged in a U-shape on the plane P, so that, with reference to the world frame Om, the targets M0 and M1 are aligned along the longitudinal axis Omx, the targets M1, M2, M3 are aligned along the transverse axis Omy, the targets M3, M4 are aligned along the longitudinal axis Omx and the targets M0, M4 are aligned along the transverse axis Omy.

At a minimum, the set of targets comprises three non-aligned targets bounding a segment of the calibration plane P, and at least one target arranged at the origin of the world frame Om.

However, it will be noted that increasing the number of targets improves the accuracy of the acquiring system and makes it less sensitive to noise.

An aspect of the present invention relates to a method of extrinsic geometric calibration of the sensor 10 for taking three-dimensional measurements, which aims to define the geometric transformation between the sensor frame Oc and the world frame Om.

The geometric transformation is characterized by extrinsic parameters that comprise, with reference to the world frame, three angles of rotation including roll, which defines a rotation Rx about the longitudinal axis Omx, pitch, which defines a rotation Ry about the transverse axis Omy, and yaw, which defines a rotation Rz about the vertical axis Omz, and three translations including a longitudinal translation Tx, a transverse translation Ty and a vertical translation Tz.

The calibration method comprises an initial step of locating the targets M0, M1, M2, M3, M4 by means of the sensor 10 for taking three-dimensional measurements, which step makes it possible to determine the coordinates of the targets M0, M1, M2, M3, M4 in the sensor frame Oc.

In order to facilitate detection and location of the targets M0, M1, M2, M3, M4 by means of the sensor 10 for taking three-dimensional measurements, the targets M0, M1, M2, M3, M4 are each equipped with a device intended to increase their reflectivity.

Specifically, the reflectivity peaks of an object can be detected by the data-acquiring system by means of a suitable algorithm, known to those skilled in the art.

Following the initial locating step, the method comprises a first step of estimating the roll Rx, the pitch Ry and the vertical translation Tz.

The calibration plane P can be defined, in a known manner, by four parameters a, b, c, d such that any point x, y, z on the calibration plane P respects the following equation, Eq1: ax+by+cz+d=0.

The vector (a,b,c) normal to the calibration plane P in the world frame Om is denoted nm.

It will further be noted that the calibration plane P extends, longitudinally and transversely in the world frame Om along the longitudinal axis Omx and the transverse axis Omy respectively, such that the calibration plane P is at a zero height z=0 along the vertical axis Omz.

It will be recalled that the targets M0, M1, M2, M3, M4 are arranged on the ground and belong to the calibration plane P, which is at a zero altitude along the vertical axis Omz, this implying that the parameters of the calibration plane P satisfy the following equation: (am, bm, cm)=(0, 0, 1), in the world frame Om.

The normal vector in the sensor frame Oc is denoted nc, and the normal vector nm is transformed to the sensor frame Oc by rotation, this yielding the following equation: nc=Rx·Ry·Rz·[0; 0; 1]=Rx·Ry·[0; 0; 1].

It will be noted that this transformation depends neither on the yaw Rz, nor on the longitudinal translation Tx, nor on the transverse translation Ty.

The distance between the sensor 10 for taking three-dimensional measurements and the calibration plane P containing the targets M0, M1, M2, M3, M4 is characterized by the vertical translation Tz, which corresponds to the height of the sensor 10.

Specifically, the distance to a plane is such that |a·x+b·y+c·z+d|/\sqrt{(a·a+b·b+c·c)}, and since (a, b, c) is a unit normal vector \sqrt{√(a·a+b·b+c·c)}=1.

When the measurement-taking sensor 10 is located at a distance Tz from the plane P:

$$\vert a . x + b . y + c . z + d \vert = Tz and$$

$$x = 0 , y = 0 , z = 0 , and hence \vert d \vert = Tz$$

In addition, for each point formed by the targets M0, M1, M2, M3, M4 on the calibration plane P, the equation Eq1 described above gives nc·Mci+d=0 with Mci the coordinates of the indexed target M0, M1, M2, M3, M4, the character “i” designating the index in the sensor frame Oc, Mc1 for example defining the coordinates of target M1 in the sensor frame Oc.

The first step of estimating the roll Rx, the pitch Ry and the vertical translation Tz consists in minimizing a first cost function based on the geometric characteristic of arrangement of the targets M0, M1, M2, M3, M4 on the piece of ground forming the calibration plane P.

The first cost function used in the first estimating step is the following cost function:
cost (Rx, Ry, Tz)=|Rx·Ry·[0; 0; 1]·Mci+Tz|, with Mci the coordinates of the indexed target M0, M1, M2, M3, M4, in the sensor frame Oc.

The first estimation consists in varying predictions of the terms Rx, Ry, Tz until the cost function approaches zero as much as possible, so as to obtain an estimate of the roll Rx, the pitch Ry and the vertical translation Tz of the sought geometric transformation for passing from the sensor frame Oc to the world frame Om.

The method according to an aspect of the invention comprises a second estimating step, which aims to estimate the yaw Rz, the longitudinal translation Tx and the transverse translation Ty by minimizing a plurality of second cost functions based on the geometric characteristics of alignment of the targets M1, M2, M3, M4 in the world frame Om that were described above.

It will be recalled, with reference to the world frame Om, that the targets M0 and M1 are aligned along the longitudinal axis Omx, the targets M1, M2, M3 are aligned along the transverse axis Omy, the targets M3, M4 are aligned along the longitudinal axis Omx and the targets M0, M4 are aligned along the transverse axis Omy.

Also, it will be noted that, in the world frame Om, the coordinates Mm1·x, Mm2·x, Mm3·x of the targets M1, M2, M3 along the longitudinal axis Omx are zero, respectively, and that the coordinate Mm2·y of the target M2 along the transverse axis Omy is zero, because the target M2 is at the origin of the frame Om.

In addition, Mmi=Hinv*[Mci;1] for each target M0, M1, M2, M3, M4, with Mmi the coordinates of each target M0, M1, M2, M3, M4 in the world frame Om, Hinv the inverse transformation of the homogeneous transformation allowing the sensor frame Oc to be passed to from the world frame Om and Mci the coordinates of the indexed target M0, M1, M2, M3, M4 in the sensor frame Oc.

The second cost functions used in the second estimating step of the method are the following cost functions:

$$cost ( Rz , Tx , Ty ) = ‖ Mm 0. y - Mm 1. y ‖ ,$$

$$cost ( Rz , Tx , Ty ) = ‖ Mm 3. y - Mm 4. y ‖ ,$$

$$cost ( Rz , Tx , Ty ) = ‖ Mm 0. x - Mm 4. x ‖ ,$$

$$cost ( Rz , Tx , Ty ) = ‖ Mm 1. x ‖ ,$$

$$cost ( Rz , Tx , Ty ) = ‖ Mm 2. x ‖ ,$$

$$cost ( Rz , Tx , Ty ) = ‖ Mm 3. x ‖ ,$$

$$cost ( Rz , Tx , Ty ) = ‖ Mm 2. y ‖ ,$$

with Mmi·y the coordinate of the indexed target M0, M1, M2, M3, M4, along the transverse axis Omy, in the world frame Om, and Mmi·x the coordinate of the indexed target M0, M1, M2, M3, M4, along the axis Omx, in the world frame Om. For example, Mm0·y designates the y-coordinate of target M0 along the transverse axis Omy.

Advantageously, an aspect of the invention provides a method of calibration of a measurement-taking lidar sensor, that does not require the distance separating the various targets to be known.

Thus, the distance between the targets can be chosen depending on the position of the measurement-taking sensor.

Thus, an aspect of the invention provides a calibration method that is flexible and quick to implement, the calibration targets being able to be deployed with few constraints on their position relative to the measurement-taking sensor to be calibrated.

Of course, an aspect of the invention is described in the above by way of example. It will be understood that those skilled in the art will be able to produce various variant embodiments of the invention without thereby departing from the scope of the invention.

It should be noted that all the features, such as should be clear to those skilled in the art from the contents of the present patent application, even if concretely they have been described only in relation to other specific features, individually or in any combination, may be combined with other features or groups of features disclosed herein, provided this has not been expressly excluded or technical circumstances make such combinations impossible or meaningless.

1. An extrinsic geometric calibration method for a system for acquiring three-dimensional data comprising at least one sensor for taking three-dimensional measurements that is associated with a sensor frame, which method aims to define the geometric transformation between the sensor frame and a world frame, by set of static targets, the geometric transformation including extrinsic parameters that comprise, with reference to the world frame, three angles of rotation including roll about a longitudinal axis, pitch about a transverse axis and yaw about a vertical axis, and three translations including a longitudinal translation, a transverse translation and a vertical translation, wherein the set of targets comprises at least three non-collinear targets that are arranged on a flat surface forming a calibration plane, and that are placed so that the set of targets comprises at least:
two targets aligned along the longitudinal axis of the world frame,
two targets aligned along the transverse axis of the world frame
and a target arranged at the origin of the world frame, the method comprising at least:
an initial step of locating the targets, which aims to determine the coordinates of the targets in the sensor frame by the sensor for taking three-dimensional measurements,
a first step of estimating the roll, the pitch and the vertical translation by minimizing a first cost function based on the geometric characteristic of arrangement of the targets on said flat surface forming a calibration plane, and
a second step of estimating the yaw, the longitudinal translation and the transverse translation by minimizing a plurality of second cost functions based on the geometric characteristic of alignment of the targets in the world frame.

2. The calibration method as claimed in claim 1, wherein the first cost function used in the first estimating step is the following cost function:
cost (Rx, Ry, Tz)=|Rx·Ry·[0; 0; 1]·Mci+Tz| with Mci the coordinates of the indexed target in the sensor frame.

3. The calibration method as claimed in claim 1, wherein the second cost functions used in the second estimating step are at least the following cost functions:
$$cost ( Rz , Tx , Ty ) = ‖ Mm 0. y - Mm 1. y ‖ ,$$
$$cost ( Rz , Tx , Ty ) = ‖ Mm 1. x ‖ ,$$
$$cost ( Rz , Tx , Ty ) = ‖ Mm 2. y ‖ , and$$
$$cost ( Rz , Tx , Ty ) = ‖ Mm 2. y ‖ ,$$
with Mm0·y and Mm1·y the coordinates along the transverse axis of the targets aligned along the longitudinal axis in the world frame, and with Mm1·x, Mm2·x the coordinates along the longitudinal axis of the targets aligned along the transverse axis in the world frame, and with Mm2·x, Mm2·y the coordinates along the longitudinal axis and the transverse axis of the target arranged at the origin of the world frame.

4. The calibration method as claimed in claim 1, wherein the set of targets comprises five targets that are arranged in a U-shape on the calibration plane, so that, with reference to the world frame, two targets are aligned along the longitudinal axis, three targets are aligned along the transverse axis, two targets are aligned along the longitudinal axis and two targets are aligned along the transverse axis and one target is arranged at the origin of the world frame.

5. The calibration method as claimed in claim 4, wherein the second cost functions used in the second estimating step are at least the following cost functions:
$$cost ( Rz , Tx , Ty ) = ‖ Mm 3. y - Mm 4. y ‖ ,$$
$$cost ( Rz , Tx , Ty ) = ‖ Mm 0. x - Mm 4. y ‖ , and$$
$$cost ( Rz , Tx , Ty ) = ‖ Mm 3. x ‖ ,$$
with Mm3·y and Mm3·y the coordinates along the transverse axis of the targets aligned along the longitudinal axis in the world frame, and with Mm0·x, Mm4·x the coordinates along the longitudinal axis of the targets aligned along the transverse axis and with Mm3·x the coordinate along the longitudinal axis of one of the three targets aligned along the transverse axis.

6. The calibration method as claimed in claim 1, wherein the targets are each equipped with a device for facilitating reflectance of light rays in order to facilitate the initial step of locating the targets by the sensor for taking three-dimensional measurements.

7. The calibration method as claimed in claim 1, wherein said sensor for taking three-dimensional measurements is a lidar.
